(19) United States
(12) Patent Application Publication
(10) Pub. No.: US 2005/0100874 A1
(43) Pub. Date: May 12, 2005

(54) Dual mode interactive reference book

(76) Inventor: Bezalel Arkush, Weehawken, NJ (US)

Correspondence Address: ROBERT W. J. USHER;PATENT AGENT, 1133 BROADWAY, #1515, NEW YORK, NY, 10010, US

(21) Appl. No.: 10/798,833

(22) Filed: Mar. 10, 2004

Related U.S. Application Data
(60) Provisional application No. 60/453,347, filed on Mar. 10, 2003.

(51) Int. Cl. G09B 5/00

(52) U.S. Cl. 434/317

(57) ABSTRACT

An interactive self-test book has pages printed with sets of questions and multiple choice answers and unique page identifying indicia of conductive ink. A page recognition device is pivotable on a page support to bring electrical contacts into and out of connection with the ink. A series of question and answer buttons associated status and YES and NO lamps, speaker, and total score display are mounted on the support for operation by a processor. The score is increased for all questions correctly answered at the first attempt for on any page. A correct second attempt normally lights a YES lamp and emits a sound without increasing the score. Results of prior attempts at any question are stored so that on returning to a page, same YES lamps and NO lamps are relit permitting the person to review and improve on the prior attempt.

### RELATED APPLICATION

This application claims priority from provisional application 60/453,347 filed Mar. 10, 2003, the disclosure of which is incorporated herein by reference.

### FIELD OF THE INVENTION

The invention relates to an dual mode interactive reference book (SmartBook) which can be used simply for reference but which also provides a progressive self testing facility enabling users to test themselves by performing question and answer routines on information topics printed on book pages that they have read.

### BACKGROUND OF THE INVENTION

Self-testing books with information on topic and questions and answers thereon are widely used for examination priming and general learning. However, there remains a need for maintaining the score rapidly and automatically and for permitting successive attempts without the user needing to mark the book and to use and carry additional marking implements

### SUMMARY OF THE INVENTION

It is an object of the invention to provide a self-testing reference book in which a running total of the score is maintained rapidly and automatically.

It is a further object of the invention to provide a self-testing reference book in which the score is progressively totaled as the users moves from page to page, at any position in the book, whether forward, or backward to any page in any position at any time.

According to one aspect, the invention provides an interactive self-test book comprising: a plurality of pages each page being printed with a sets of questions and multiple choice answers unique to the page; unique page identifying indicia on each page distinguishing the page from each other page; means for supporting a selected one of the plurality of pages page for reading by a person using the book; a page recognition device mounted on the support means for movement into and out of registration with the page identifying indicia between a page changing position and an indicia reading position; a plurality of question buttons mounted on the supporting means for actuation by a user to select a question to be answered; a plurality of answer buttons mounted on the supporting means for actuation by a user to select an answer to a question which has been selected by actuation of a question button; indicating and display means having at least one of visual and audible means for indicating to the person whether a selected answer is correct and for displaying a score to the person. The book includes an electronic processing means of the comprising a store of data corresponding to all sets of questions and their correct answers and to the indicia identifying the respective individual pages on which the respective individual sets of questions and multiple choice answers are printed and for totalizing the score when a correct answer is selected. Mean are provided for connecting the electronic processing means to the page recognition device for identifying the page and question and answer set selected by the person; to the question buttons and to the answer buttons for determining, in response to actuation of a question button and then an answer button, that an answer button selected is one of correct and incorrect, for increasing the score in response to a determination that the answer button selected is correct and to the indicating and display means for operating the indicating and display means to display an increased score and actuate at least one of visual and audible means to indicate that the answer button selected correspond to one of a correct answer and incorrect answer.

The indicating and display means may have at least one of visual and audible means for indicating to the person the question button that has been actuated and said at least one of visual and audible means may be a status lamp adjacent the question button and which status lamp is lit up when the question button is actuated. The one of visual and audible means may also comprises a YES lamp and a NO lamp adjacent the question button actuated, which lamps are, respectively, lit when the answer button actuated corresponds to one of a correct answer and incorrect answer, respectively.

The the page recognition device may be mounted on the support means for pivotal movement into and out of registration with the page identifying indicia which may be a layer of conductive ink with the recognition device comprising a surface connector having a series of contacts on a connecting face for electrical connection with the conductive ink layer in the indicia reading position.

The page supporting means may conveniently comprise a rectangular board having an inner surface and a lower, horizontal edge portion joined at a corner to an outer free edge portion and a circuit component housing extends dog leg fashion along said lower horizontal edge portion through said corner and along said free edge portion and upstands from said inner surface cooperating with said inner surface to provide a page receiving recess for locating a stack of pages. The question buttons and answer buttons conveniently extend along adjacent edge portions of the support.

The score totalizing means stores the total score for all pages for which questions have been answered in any session and in any order continuing to add to the total for a first attempt correct answers made for any page at any time. In one scoring mode, actuation of an answer button corresponding to a correct answer in a second attempt at a same question lights up, the YES lamp associated with the question button corresponding to that question but does not alter the total score but other scoring modes are possible which award a number of points reduced proportionally for each subsequent attempt to answer a same question. Review of prior attempts reinforcing the learning process is facilitated by the processing means storing results of prior attempts at any question so that on returning to a page and registering that page, same YES lamps and NO lamps are lit as previously.

In one version the book is essentially a clipboard wherein the a page recognition device comprises the clip which also to secures pages on the support when in an indicia reading position.

### BRIEF DESCRIPTION OF THE DRAWINGS

In order that the invention may be readily understood, specific embodiments thereof will now be described by way of example only and with reference to the accompany drawings in which:

FIG. 1 is a schematic plan view of a first embodiment of the invention;

FIG. 2 is an enlarged schematic plan view of a question key shown in FIG. 1;

FIG. 3 is a schematic circuit diagram of the first embodiment;

FIG. 4 is flow diagram illustrating operational steps of the invention;

FIG. 5 is another embodiment of in the form of a clip board; and,

FIG. 6 is an alternative schematic depiction of the circuitry.

### DESCRIPTION OF PARTICULAR EMBODIMENTS

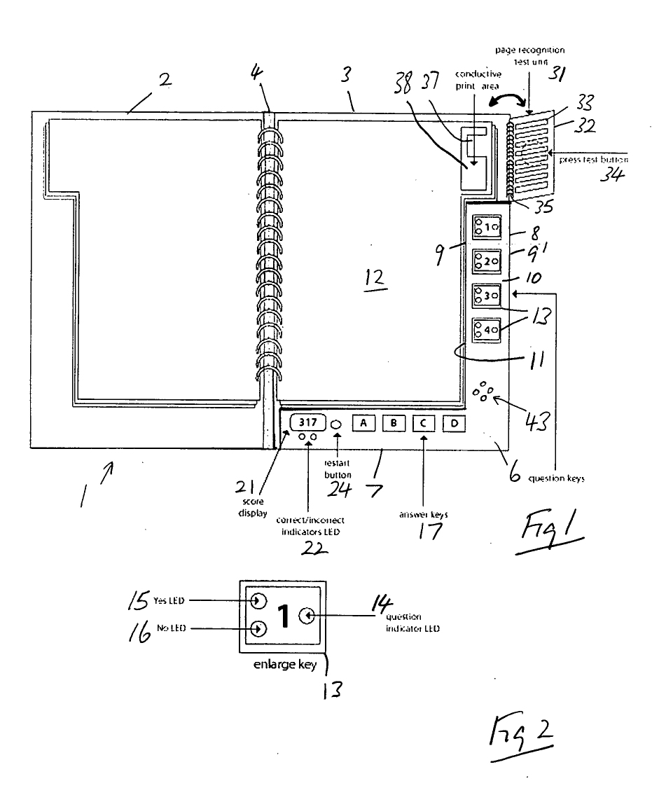

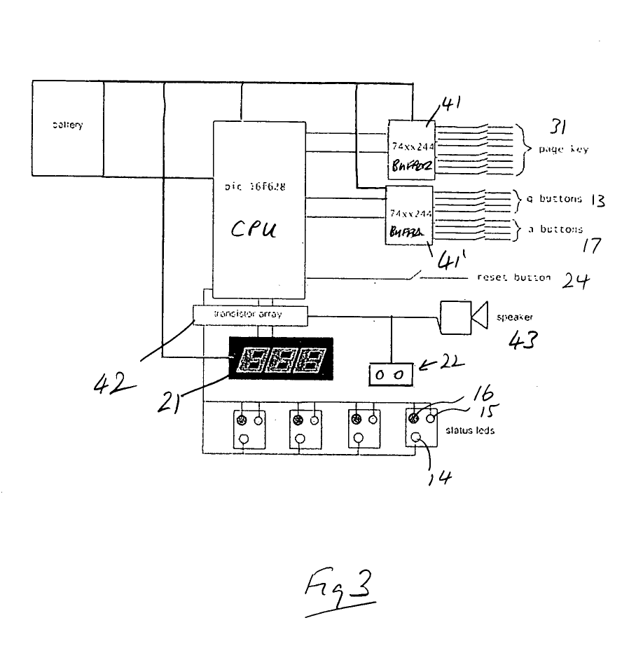

As shown particularly in FIGS. 1 and 2, the SmartBook 1 comprises rectangular, front and rear covers 2 and 3, respectively, of a suitably stiff cardboard hingedly joined together along inner side edges by a spine 4.

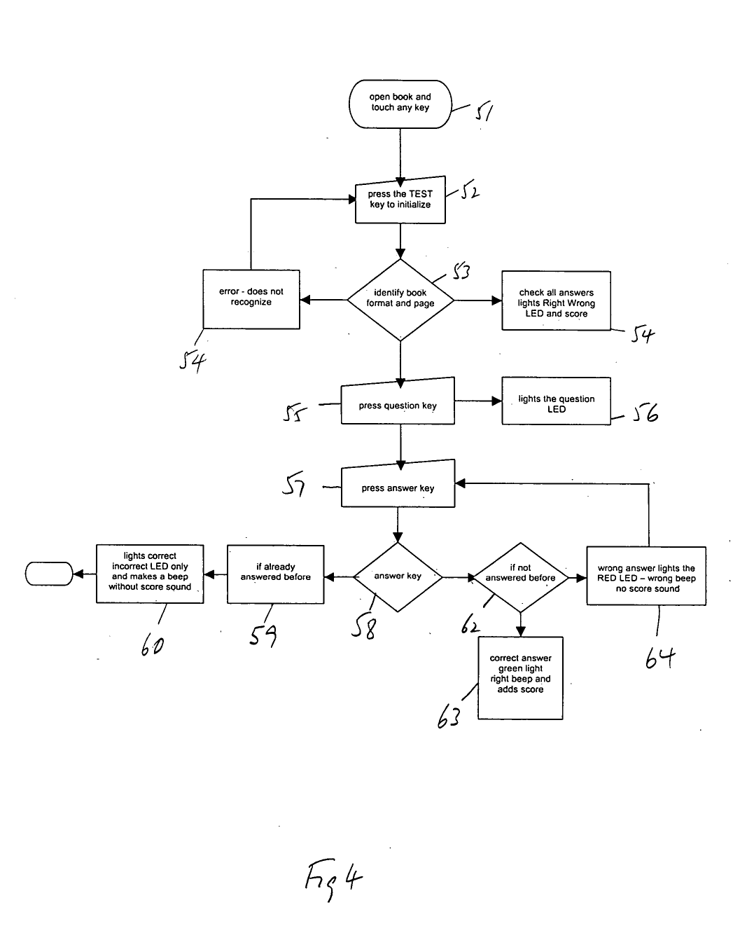

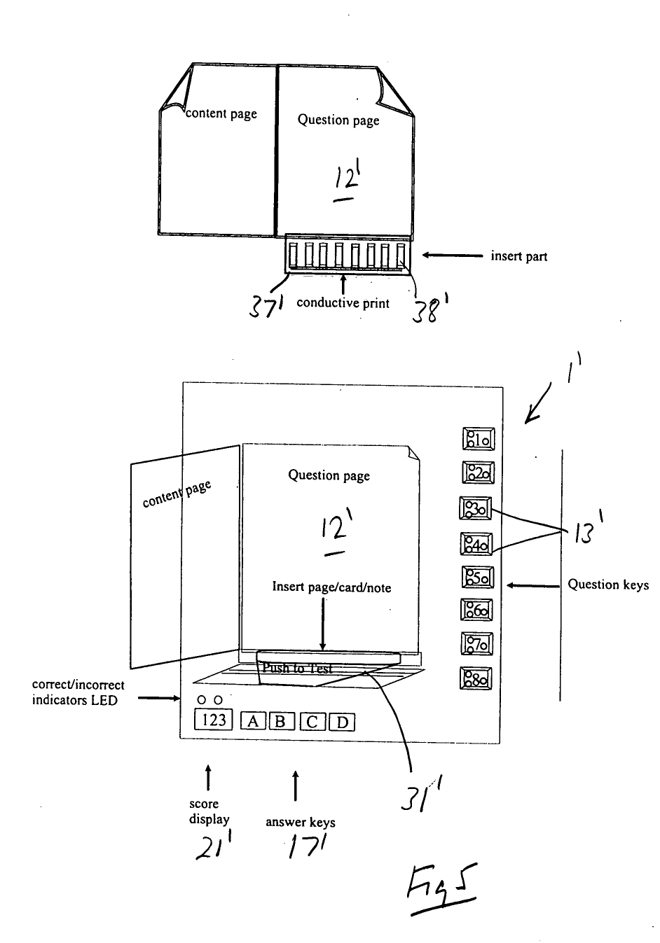

An elongate housing 6 extends, in dog-leg fashion, horizontally along an inside surface of a lower edge portion 7 of the rear cover 3 and continues upwards along an inside surface of a free edge portion 8 of the rear cover, having opposed, outer and inner elongate sidewalls 9, 9′, respectively, upstanding from the cover and bridged by a top wall 10 providing a compartment for most electronic/electrical components of the circuitry shown in FIG. 3 and defining with the cover a recess 11 receiving a stack of sheets/pages 12 printed with information on a topic and numbered questions with multiple choice answers (not shown) on that information, preferably printed adjacent the vertical portion of the housing.

An additional housing of similar construction forming a battery compartment could extend along the spine as shown in the provisional application, but the use of a smaller and lighter button type battery contained in the housing 6 is preferred.

A row of four question number buttons/keys 13, (1,2,3,4), associated with correspondingly numbered questions on the page are mounted in the housing 6 so as to be exposed on the top wall 10 of the housing. An orange status LED 14 is mounted on one side of each question button/key and a set of green and red LED s 15 and 16, respectively, for showing correct and incorrect answers, respectively on another side adjacent YES and NO legends printed on the top wall. Obviously, additional questions and keys could be provided.

A row of four answer keys/buttons 17, A, B, C, and D are mounted in the portion of the housing 6 extending horizontally along the lower edge of the cover exposed at the top wall adjacent an electronically lit total score/counter display 21, a set 22 of green and red LED s for indicating correct and incorrect answers, respectively, and a RESET button 24 for clearing the CPU score and page memory.

A page recognition and test unit 31 comprises a rigid, rectangular housing 32 carrying a row of 8 resilient metal contact strips 33 connected to respective electrical leads on an inner, page engaging face and a TEST button 34 on an opposite, outer face. The housing 32 pivotally attached along an upper part of the free edge 8 by an elongate hinge 35 to permit pivotal movement between open and closed conditions remote from the edge (as shown) to permit page changing/turning and within the edge into overlying, electrically connecting engagement with a preselected page 12 and exposing the TEST button 34 to the user.

Each page 12 has a tab portion 37 at an upper free corner having a unique pattern, track or strip of conductive ink 38 (or foil layer, or other suitable conductor etc) marked thereon, covering a unique area to distinguish that page from all other pages. When the page recognition unit is pivoted to the closed position so that the metal contact strips 33 are brought into engagement with the tab portion of that page, the ink connects with a different set/combination of contact strips for each page for a maximum of 256 pages for 8 strips. (Clearly, additional strips could be added with bigger CPU to uniquely identify more pages). Depression of the test key/button 34 sends a unique signal corresponding to the combination of contact strips connecting to the ink strip to a CPU which has all signals corresponding to all page identities stored in memory, to register that page as currently in use so that the CPU operates according to the question and answer (Q & A) pattern and scoring mode associated with that individual page.

As shown in the circuit diagram of FIG. 3, output signals from the page recognition and test unit 31 and TEST button and from the question and answer buttons 13 and 17 are fed to the CPU via respective tristate bus buffers 41 and 41′, while the output signals from the CPU operate a transistor switching array 42 which energizes the status LEDs 14-16 and 22, the counter display and a speaker 43. The RESET button outputs directly to the CPU to reset the score total to zero and to de-register the identity of the last page.

In operation, a user opens the cover to expose the first Q&A page and presses any button/key which energizes the CPU and total score display lamps, as indicated by box 51. The user then depresses the test button of the page recognition unit, as indicated by box 52, both to press the unit down aqainst the first page urging the contact strips into reliable electrical connection with the conductive ink trace thereon to identify the page and causing the page identifying signal to be sent via the buffer to the CPU/microprocessor, registering the page and causing the CPU to operate in accordance with the Q & A pattern and scoring mode associated with that particular page as shown by box 53. The CPU also displays any prior score and relights appropriate status LEDs for that page, according to the prior result, as indicated in box 54, unless the RESET button has been depressed subsequent to a prior session.

Having read the text on that page, the user selects and depresses a question number button, as indicated by box 55, closing a circuit to energize the orange status lamp on that button, as indicated by box 56, and selects and depresses one of the answer buttons A, B, C or D, as indicated by box 57. The CPU determines whether the question has been attempted before, as indicated by box 58. If that question has been attempted previously, as shown by box 59, (when the user has returned to a page to improve on a prior attempt on the same question which had previously produced an incorrect answer or is simply making a second attempt while remaining on the same page), a correct or incorrect answer will merely operate the status lights and speaker 43 to emit an appropriate sound without affecting the score, as indicated by box 60.

As indicated by box 62, if the question has not been attempted previously, either the ‘correct’ or ‘incorrect’ LED of the set 22 is lit up, as shown by boxes 63 and 64, respectively, according to whether the answer is correct or incorrect, respectively, and in lighting up the green LED or red LED on the number button selected, with the orange status lamp 14 being simultaneously extinguished.

A correct answer also results in an increase in the displayed total score and energizing of the speaker 43 to emit a ‘right’ beep while an incorrect answer results only in a different ‘no score’ sound.

Thus, the totalizer or adder in the CPU records in memory the total score for all pages for which questions have been answered in any session continuing to add to the total for first attempt correct answers made for any page at any time.

Pressing the RESET button will eliminate all scores, resetting the totalizer and the registration of the identity of a currently registered page.

Even before all answers are completed on a page, it is possible to turn back to a previous page at any time and depress the ‘test’ button to display the LEDs on the question buttons indicating whether previous answers were correct.

Changing the page, requires lifting the page detection unit 31 to pivot it outward about the outer edge 8 of the rear cover away from the page, out of overlying relation with the tab portion disconnecting from the unique ink pattern of that page. To start on a new page, the page detection unit is pivoted back to lie within the edge 8 of the cover, to overlie the tab portion of the new page and connect to the unique conductive ink pattern and the ‘TEST’ button depressed to repeat the procedure above.

The book is timed to power down after ten minutes of non-entry/use and can be restored to display the previous score on touching any key.

In modifications, flat or paper batteries may be used (often known as power paper).

A set of information sheets may bound together be in the form of a detachable boolet and interchanged with another similar booklet on a different topic.

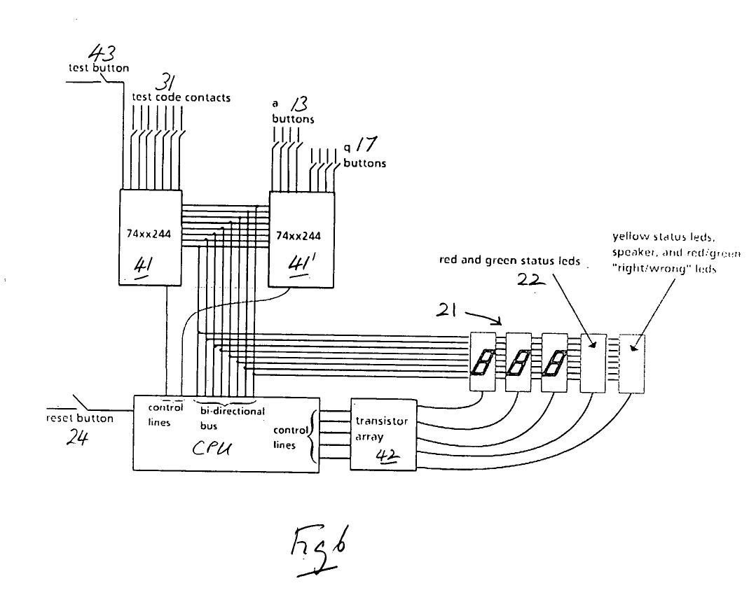

In another version of the book shown schematically in FIG. 5, and termed SmartPad, the page recognition and test unit may be incorporated in a page/sheet holding clip forming, essentially a sheet supporting clipboard.

Several scoring modes are shown below. The award of points for subsequent correct attempts encourages the user to persist retrying questions which have been previously answered incorrectly increasing the learning experience. The terms button/key are intended to include devices operated by touching or covering with a person's finger, such as touch pads, proximity, capacitative or optical.

Scoring Methods:

Score System I

For the first time you got a right answer you get a point—answering again in the same sequence provides you with a correct/incorrect answer but does no give you additional score.

The final score once you answered all the questions should be a % of a 100%

Score System II

The system gives you a different score for every attempt that you are doing.

If there are 4 answer keys then
for answering the first time right you will get 4 points
for answering the second time right you will get 3 points
for answering the third time right you will get 2 points
for answering the fourth time right you will get 1 point

If there are 6 answer keys then
for answering the first time right you will get 6 points
for answering the second time right you will get 5 points
for answering the third time right you will get 4 points
for answering the fourth time right you will get 3 point
for answering the fifth time right you will get 2 points
for answering the sixth time right you will get 1 point
   Scoring System III

The system scoring for very young children is comprised of LEDs in the shape of stars instead of a numeric display

Each right answer is lighting a star instead of a numeric score.

1. An interactive self-test book comprising:
a plurality of pages each page being printed with a sets of questions and multiple choice answers unique to the page;
unique page identifying indicia on each page distinguishing the page from each other page;
means for supporting a selected one of the plurality of pages page for reading by a person using the book;
a page recognition device mounted on the support means for movement into and out of registration with the page identifying indicia between a page changing position and an indicia reading position;
a plurality of question buttons mounted on the supporting means for actuation by a user to select a question to be answered;
a plurality of answer buttons mounted on the supporting means for actuation by a user to select an answer to a question which has been selected by actuation of a question button;
indicating and display means having at least one of visual and audible means for indicating to the person whether a selected answer is correct and for displaying a score to the person;
electronic processing means comprising a store of data corresponding to all sets of questions and their correct answers and to the indicia identifying the respective individual pages on which the respective individual sets of questions and multiple choice answers are printed and for totalizing the score when a correct answer is selected;
means for connecting the electronic processing means to the page recognition device for identifying the page and question and answer set selected by the person; to the question buttons and to the answer buttons for determining, in response to actuation of a question button and then an answer button, that an answer button selected is one of correct and incorrect, for increasing the score in response to a determination that the answer button selected is correct and to the indicating and display means for operating the indicating and display means to display an increased score and actuate at least one of visual and audible means to indicate that the answer button selected correspond to one of a correct answer and incorrect answer.

2. An interactive self-test book according to claim 1 wherein the indicating and display means has at least one of visual and audible means for indicating to the person the question button that has been actuated.

3. An interactive self-test book according to claim 2 wherein said at least one of visual and audible means is a status lamp adjacent the question button and which status lamp is lit up when the question button is actuated.

4. An interactive self-test book according to claim 1 wherein said at least one of visual and audible means to indicate that the answer button selected corresponds to one of a correct answer and an incorrect answer comprises a YES lamp and a NO lamp adjacent the question button actuated, which lamps are, respectively, lit when the answer button actuated corresponds to one of a correct answer and incorrect answer, respectively.

5. An interactive self-test book according to claim 3 wherein said at least one of visual and audible means to indicate that the answer button selected corresponds to one of a correct answer and an incorrect answer comprises a YES lamp and a NO lamp adjacent the question button actuated, which lamps are, respectively, lit when the answer button actuated corresponds to a correct answer and an incorrect answer, respectively.

6. An interactive self-test book according to claim 3 wherein the page recognition device is mounted on the support means for pivotal movement into and out of registration with the page identifying indicia.

7. An interactive self-test book according to claim 6 wherein the page identifying indicia comprises a layer of conductive ink and the recognition device comprises a surface connector having a series of contacts on a connecting face for electrical connection with the conductive ink layer in the indicia reading position.

8. An interactive self-test book according to claim 7 wherein the page supporting means comprises a rectangular board having an inner surface and a lower, horizontal edge portion joined at a corner to an outer free edge portion and a circuit component housing extends dog leg fashion along said lower horizontal edge portion through said corner and along said free edge portion and upstands from said inner surface cooperating with said inner surface to provide a page receiving recess for locating the pages as a stack.

9. An interactive self-test book according to claim 1 wherein said question buttons and said answer buttons extend along adjacent edge portions of the support.

10. An interactive self-test book according to claim 1 wherein the means for totalizing the score stores the total score for all pages for which questions have been answered in any session and in any order continuing to add to the total for a first attempt correct answers made for any page at any time.

11. An interactive self-test book according to claim 4 wherein actuation of an answer button corresponding to a correct answer in a second attempt at a same question lights up, the YES lamp associated with the question button corresponding to that question but does not alter the total score.

12. An interactive self-test book according to claim 11 wherein the processing means stores results of prior attempts at any question so that on returning to a page and registering that page, same YES lamps and NO lamps are lit as in the prior attempt permitting the person to review the prior attempt.

13. An interactive self-test book according to claim 1 wherein the a page recognition device comprises a clip arranged to secure pages on the support when in an indicia reading position.

14. An interactive self-test book according to claim 1 the pages also contain information to which the questions are directed providing a dual function as a reference book.
